(19) United States
(12) Patent Application Publication
(10) Pub. No.: US 2026/0148035 A1
(43) Pub. Date: May 28, 2026

(54) COMPUTER OPERATED METHOD OF PROVIDING GUIDANCE TO A USER

(71) Applicant: INNOVATE PRODUCT DESIGN LTD, SALISBURY (GB)

(72) Inventors: Richard Alastair SWANWICK, SALISBURY (GB); Adam DAVIES, SALISBURY (GB); Emerald Junn MENDOZA, SALISBURY (GB); Kevin COPE, SALISBURY (GB); Tobias KING, SALISBURY (GB); James Michael MCINERNY, SALISBURY (GB)

(73) Assignee: INNOVATE PRODUCT DESIGN LTD, SALISBURY (GB)

(21) Appl. No.: 19/397,999

(22) Filed: Nov. 23, 2025

(30) Foreign Application Priority Data
Nov. 22, 2024 (GB) 2417230.6

(51) Int. Cl. G06N 3/006

(52) U.S. Cl. CPC G06N 3/006

(57) ABSTRACT

Computer operated systems and methods of providing guidance to a user using Artificial Intelligence. A software interface may receive a user input and the user input is added to a first dataset. A first processing module trained including guidance rules for an industry performs processing. The user input may be processed using the first dataset to produce an enhanced input which may be sent to an output and/or sent to a second processing module. The second processing module may answer the enhanced input using a second dataset. An output may be received from the second processing module and relayed to the interface for the user.

### CROSS REFERENCE TO RELATED APPLICATIONS

This application claims priority under 35 U.S.C. § 119 to GB patent application no. 2417230.6 filed Nov. 22, 2024, the disclosure of each which is incorporated herein by reference in its entirety as if fully set forth.

### TECHNICAL FIELD

The present technology relates to a computer operated method of providing guidance to a user, in particular in a resource-efficient, adaptable and responsive manner for time-pressured input; more particularly but not exclusively so as to suit guidance in relation to innovation and entrepreneurial activities.

### BACKGROUND

U.S. Pat. No. 11,990,139 (SANDREW) discloses a system that conducts dialogs using artificial intelligence. The system includes a dialog manager that manages a dialog with a user, a natural language understanding module that processes user inputs, and a natural language generation module that generates responses.

US 2024 0 104 308 (FRANCIS) discloses systems and methods for embodied multimodal artificial intelligence question answering and dialogue with commonsense knowledge wherein the system integrates visual, auditory, and textual inputs to understand and respond to user queries and uses local processing for initial input handling and remote servers for complex analysis and response generation.

EP 4 064 165 (LANCEWICKI et al) discloses artificial intelligence agents for predictive searching wherein the system predicts user search queries based on historical data and contextual information, and processes initial inputs locally and sends them to remote servers for advanced processing and result generation.

### SUMMARY

According to one aspect of the present technology, there is provided a computer operated method of providing guidance to a user using Artificial Intelligence. The method may comprise the steps of: receiving a user input at an interface; adding the user input to a first dataset; processing in a first processing module, wherein the first processing module has been trained including guidance rules for an industry; processing the user input at the first processing module using the first dataset to produce an enhanced input; sending the enhanced input to a second processing module; answering the enhanced input using a second dataset in the second processing module; receiving an output from the second processing module; relaying the output to the interface for the user.

According to another aspect, a computer operated method of providing guidance to a user using Artificial Intelligence is provided. The method may comprise the steps of: receiving a user input at an interface; adding the user input to a first dataset; processing the input in a first processing module, wherein the first processing module has been trained including guidance rules for an industry; interrogating the first dataset to predict inputs; processing a plurality of user inputs at the first processing module to produce enhanced inputs; sending one or more enhanced input to a second processing module; answering the enhanced input using a second dataset in the second processing module; receiving an output from the second processing module; relaying the output to the interface for the user.

According to another aspect, a non-transitory, computer-readable medium comprising program code is provided that, when executed by one or more processors of a computer system, causes the one or more processors to perform a method of providing guidance to a user using artificial intelligence according to any one of the aforementioned method aspects.

According to another aspect, a computing system for providing guidance to a user using artificial intelligence is provided. The computing system is configured to perform any one of the aforementioned method aspects.

### BRIEF DESCRIPTION OF FIGURES

Preferred embodiments of the method of the present invention are described by way of example only and with reference to the Figures in which:

FIG. 1 shows a representative flowchart of a first embodiment of a method according to the present technology;

FIG. 2 shows a representative flowchart of a second embodiment of a method according to the present technology;

FIG. 3 shows a representative flowchart of a third embodiment of a method according to the present technology; and

FIG. 4 illustrates a block diagram of an exemplary computing system for implementing methods of providing guidance to a user using Artificial Intelligence according to some embodiments.

### DETAILED DESCRIPTION

The following problems have been identified.

There has been a great increase in computing methods of providing guidance in recent times, with increasing artificial intelligence enabled methods, for example where user inputs are enhanced locally on electronic devices such as smartphones or personal computers. These methods typically involve receiving user inputs, processing them using locally stored datasets, and providing immediate responses based on the local processing capabilities. However, these methods may lack the ability to leverage extensive external datasets or advanced processing capabilities currently only available on remote servers.

There are also methods or systems where user inputs are sent to remote servers for processing. These systems utilise the extensive computational power and large datasets available on remote servers to process user inputs and generate responses. While these methods can provide more comprehensive and accurate responses, they often suffer from latency issues due to the need to transmit data back and forth between the user device and the remote server.

Personal computers in current times often use a hybrid approach where basic data processing and user input handling are performed locally. For more resource-intensive tasks, such as running machine learning models or accessing large databases, the enhanced input is sent to cloud-based services. These services perform the necessary computations and return the results to the local computer, thereby combining the speed of local processing with the power of remote servers.

Additionally, smartphones initially process user inputs locally to provide quick responses. For more complex tasks, such as language translation or advanced data analysis, the enhanced input is sent to remote servers. These servers utilise computational power and large datasets to generate accurate and comprehensive responses, which are then relayed back to the smartphone.

Oftentimes when a person has an idea it can be common to check the state of the art and world wide web for further information on the idea, background to it, other ideas, and the like. However, even with the advent of artificial intelligence enabled search assistance, it can be difficult to find targeted or relevant guidance, meaning ideas may be lost or discarded shortly.

According to one aspect the present technology there is provided a computer operated method of providing guidance to a user using Artificial Intelligence, comprising the steps of: receiving a user input at a software interface; adding the user input to a first dataset; processing in a first processing module, wherein the first processing module has been trained including guidance rules for an industry; processing the user input at the first processing module using the first dataset to produce an enhanced input; sending the enhanced input to a second processing module; answering the enhanced input using a second dataset in the second processing module; receiving an output from the second processing module; relaying the output to the user.

Another aspect of the disclosed embodiments includes an autonomous apparatus. The autonomous apparatus includes a processor and a memory. The memory includes instructions that, when executed by the processor, cause the processor to use a first machine-learning model initially trained using training data comprising industry standard guidance to provide the first processing module and which continues to operate using or within the first dataset. The apparatus will process the training data and operate the first dataset, that the first processing module may continue to access for processing and continuously add to and improve.

The first processing module may comprise a machine learning module.

The term ‘first dataset’ may be envisaged to comprise augmented training data, such as a local repository populated by current and historical user behaviour from use of the method, or other sources such as a webcall or API (Application Programming Interface) call.

The apparatus may subsequently make requests to a remote server hosting the second processing module with a second dataset, which server may be provided by a third party, when the first processing module identifies a need. Such need identification may be predicated on a prediction of (a) a future user input or (b) inability to sufficiently answer a processed input.

In this way the method of the present technology enables a person, or user, to quickly seek targeted guidance on ideas, for example but not limited to inventions or business ideas.

A pre-processing stage may be envisaged to receive a functional representation of an input from the user and add this to the first dataset for storage as well as a prompt to the first processing module. The first processing module then interrogates the first dataset containing the stored functional representations and inputs, as a start-point for processing.

It may be envisaged that the functional representation may comprise a textual, image or documentary input. The method and software interface may therefore be envisaged to receive the input via an upload or a textual interaction.

It may be further envisaged that a plurality of action predictions based on an input may be contemporaneously generated by the first processing module whilst the input is enhanced. This may provide a plurality of prepared enhanced inputs for the second processing module. Alternatively or additionally, the enhanced input may be provided to the user as an output, wherein the addition of user inputs to the first dataset progressively enables the first processing module to access an enhanced input that is sufficient for, or identified to be sufficient for, the user's needs, and does not therefore require sending to the second processing module.

In some embodiments therefore the method of the present technology comprises a user need identification engine, wherein such embodiment of the method comprises the following in some approaches: a computer operated method of providing guidance to a user using artificial intelligence, comprises the steps of: receiving a user input at a software interface; adding the user input to a first dataset for processing in a first processing module, wherein the first dataset includes guidance rules for an industry; processing the user input at the first processing module to produce an enhanced input; operation of a user need identification engine to predict if the enhanced input is sufficient to provide an output for the user and relaying the enhanced input to the user and if the user need identification engine predicts the enhanced input will not be sufficient as an output sending the enhanced input to a second processing module; answering the enhanced input using a second dataset in the second processing module; receiving an output from the second processing module; relaying the output to the user.

The user need identification engine may be based upon the first dataset and additions thereto, which may comprise analysis of the user inputs, patterns thereof, for example repeat processing requests.

If a predicted future input is simple enough to be handled by the first processing module, these do not need to be sent to the second processing module. If they are deemed in need of more compute to provide a satisfactory answer, they will be sent to the second processing module. In this way it may be envisaged that the inputs are generated and handled (either locally or remotely as needed) prior to them being explicitly requested by the user.

In some embodiments of the method the subsequently generated outputs or enhanced or processed inputs are stored and retrieved if needed, or otherwise disregarded when the first processing module predicts they are no longer to likely be useful-trying to predict a user's future inputs. If this proves to be too power or processor intensive (perhaps for older devices), then this may be a user and/or system activated choice to help save battery and improve overall performance at the expense of some slower response times.

In this way the embodiments of the method of the present invention thereby advantageously provide greater efficiency and effectiveness to the user by enhancing their inputs, for example locally and quickly, such that time, computational resources and the user's inputs are more efficiently used. This provides real-world benefits in economic, physical and environmental resource efficiency as well as improving access to innovation, entrepreneurship, and improvements thereto.

In some embodiments of the method, it may be envisaged that the outputs may be provided, categorised or stored as ‘cards’ of information, visually and/or structurally presented as such, and combined and/or subsequently received as a new input. In this way the method of the present invention provides a method of hybrid processing that enables a user to input an idea, problem, solution, or other phrase or prompt, wherein such input may be improved, augmented or enhanced, integrated into the first dataset, answered or enhanced by further information or data locally to provide an enhanced input or output, and if required this enhanced input may be sent to a second processing module for further elaboration.

The cards enable a visual and interchangeable and interactive means of displaying and representing potentially complex ideas thereby further advantageously providing momentum to the user and/or fostering innovation and entrepreneurial activities where relevant.

For example in a representative non-limiting embodiment of the method it may be envisaged that the user may input the idea, such as a patent claim and a number of supporting documents or images, the first processing module may provide a number of iterations on the input, and/or expansions thereof, the user may select one or more of these enhanced inputs, so as to provide an enhancement of the claim into a number of claims, a detailed description and/or summary of the invention, the enhanced input may be further processed by the second processing module, such as so as to produce a full specification.

This output may then be sent to the user, added to the first dataset and/or passed through the first and/or second processing modules again according to user preference, with the user selecting from outputs, combining outputs and existing inputs and enhanced inputs as well as adding further inputs. The software interface may consequently provide a filing and sorting interface.

For example, it may be envisaged that the first dataset may contain without limitation, and the first processing module may process, user request patterns, input history, and incorporate contextual information such as user location, time of day, device status, and current activity patterns for example including internet search history or locally stored data and imagery. Additionally or alternatively, the first processing module may be envisaged to cross-reference such with data received from external sources, such as the industry guidance. This enriched data ensures that the enhanced input is more relevant and accurate, reducing the need for multiple iterations and advantageously improving the overall efficiency of the method and local and remote computing hardware.

In this way the user is enabled to refine their inputs, obtain new outputs and provide a systemic improvement to the quality of the first dataset, and the enhanced inputs using it, such that the enhanced input may be sufficiently helpful that it may be presented to the user for addition of further input in an improvement cycle, finally improving the quality of information of which they are in possession after use of the method.

Advantageously in this way the device of the present invention provides a system of working upon an idea, using collaboration between the user and the processing modules, enhancing, elaborating, fostering creativity, and driving iterations and innovation, which all combine to provide improved diagnostic, creative, learning tools for dealing with a user's ideas.

Additionally or alternatively by combining local and remote processing, the method of the invention leverages the strengths of both. Initial user inputs are enhanced locally to provide quick responses, reducing latency, and allowing a fast cumulative call and response improvement environment for enhancing the input. For more complex tasks, the enhanced input may then be sent to remote servers, which utilize extensive computational power and large datasets to generate accurate and comprehensive responses. This hybrid approach balances speed and computational efficiency.

The first processing module and associated first dataset ensures that the enhanced input is relevant and accurate, reducing the need for multiple iterations and improving the overall efficiency of the system.

In some embodiments of the computer operated method the enhanced input comprises processing instructions for use in processing by the second processing module.

In some embodiments of the computer operated method the first dataset comprises earlier outputs from the second processing module.

In some embodiments of the computer operated method the first processing module is located locally on electronic equipment operating the method.

In some embodiments of the computer operated method the second processing module is operated on remote data servers.

In some embodiments of the computer operated method therefore the method may comprise targeted guidance for users on progress of innovative entrepreneurial activities, based on standardised as well as locally learnt factors and guidance rules.

This standardised guidance helps organise, structure or maintain the version of the dataset locally and ensures that the processing is aligned with best practices and methodologies, reducing errors and improving the efficiency of the method.

In some embodiments of the computer operated method the method maintains a version of the first dataset locally.

In some embodiments of the computer operated method the method comprises a step of predicting future user inputs by leveraging the first dataset, for example using a user need identification engine. For example, such user need identification engine may contemporaneously prepare a plurality of enhanced inputs locally, ready for instantaneous sending to the second processing module. This predictive capability ensures that the system can provide quick and efficient responses to user inputs, minimizing downtime and enhancing user experience and advantageously enhancing the method's efficiency for the computational hardware operated.

In this way the enhanced input includes processing instructions for use by the second processing module, including the user need identification and prediction engine, ensuring that the input is handled efficiently and accurately.

In some embodiments of the computer operated method the method therefore comprises a step of contemporaneously preparing a plurality of the enhanced inputs locally for instantaneous sending to the second processing module.

In this way it may be envisaged that an embodiment of the computer operated method of providing guidance to a user using artificial intelligence, may comprise the steps of: receiving a user input at a software interface; adding the user input to a first dataset for processing in a first processing module, wherein the first dataset includes guidance rules for an industry; processing the user input at the first processing module to produce an enhanced input; operation of a user need identification engine to predict if one or more enhanced input will provide a sufficient output for the user and preparing one or more enhanced input for the second processing module; answering the enhanced input using a second dataset in the second processing module; receiving an output from the second processing module; relaying the output to the user.

In some embodiments of the computer operated method the first processing module comprises analysing user request patterns, input, history, and incorporating contextual information including standardised guidance rules.

In some embodiments of the computer operated method the datasets comprise a large language model. In other embodiments the second dataset is maintained separately to the first dataset, and/or may be local.

The datasets may be envisaged to be added to or enhanced by standard guidance, prior user inputs, prior method outputs, locally devised user frameworks, pattern recognition, grammatical or linguistic improvements, historical data, problem and solution databases, real-time API (Application Programming Interface) calls, or other external or internally generated data points.

In some embodiments of the computer operated method the method comprises standardised guidance rules for innovation and/or entrepreneurial activities or industry; comprising TRIZ, SCAMPER or 5 Whys or similar; which may be sent to the second processing module as weights in relation to inputs, and/or which may be utilised to provide a locally enhanced input stage that is displayed immediately to the user, so they themselves may be enabled to provide further data to add to a first processing stage, for example which may be defined as providing a pre-processing stage.

The first processing module may comprise contextual request monitoring: for example, analysing user request patterns, history, and incorporating contextual information such as user location, time of day, device status, and current activity within the application.

Additionally, the first dataset may comprise or be trained by industry-standardized guidance for processing, maintaining an effective version of the dataset locally that is particularly well suited to the processing required for the input to provide an effective enhanced input that may also be acceptable to the user as a local output without sending to the second processing module. This local dataset may be envisaged to be continuously updated and refined based on user interactions, explicit feedback, and contextual changes.

Overall, the present technology combines the speed of local processing with the power of remote servers, ensuring that users receive timely and accurate guidance while allowing leveraging of extensive computational resources and large datasets available remotely, advantageously providing a combination of local and remote processing, enriched contextual and historical data integration partly through use of industry-standardized guidance, continuous dataset refinement, predictive capabilities, and efficient data handling. These novel aspects collectively ensure that users receive timely, accurate, and relevant guidance in particular but not solely applicable in relation to innovative entrepreneurial activities.

The method of some embodiments may be seen as particularly advantageous for providing guidance to users engaged in innovative entrepreneurial activities, where quick and accurate responses are crucial for maintaining momentum and fostering creativity, wherein the standardized guidance helps in ensuring that the processing is aligned with best practices and methodologies. Additionally or alternatively, speed and guidance fosters creativity, adding to success of the activities.

It may be envisaged that in some embodiments the first processing module may be required to send a webcall to acquire recent data, for specific user inputs and/or may provide a local dataset that is updated, and sent to the second processing module on behalf of users.

Initially inputs are local to device, then will be sent via API to a third-party server. The server-host should not retain any inputs or outputs for training of its data. The data (input and output) remains the property of the user. In order to help train a local module to better predict and anticipate future requirements, it may be necessary to utilise user data through a process of a) user opting in to allow data sharing and b) a “cleaning process” to help anonymise the data so it cannot be tied to a specific user or mention details of a specific problem/invention etc. which may be achieved by using a processing module to rewrite the input to remove specifics and categorise or tag it into a type of user action.

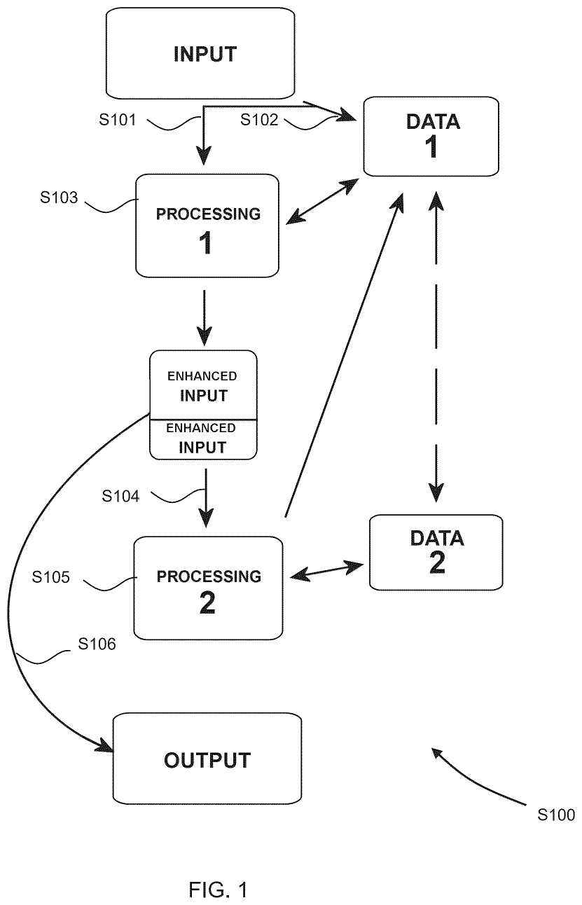

With reference to the method outlined in FIG. 1, the method (S100) of the present technology generally comprises the steps of receiving an input (S101), namely at a software interface for example a smartphone or other personal computing equipment, adding this input to a dataset (S102) to be enhanced by a first processing module; which processing module processes the input as well as additional data provided from the first dataset at the first processing module to produce an enhanced input (S103); if necessary sending the enhanced input to a second processing module (S104); answering the enhanced input using a second dataset in the second processing module (S105); receiving an output from the second processing module (S106); relaying the output to the user.

The computing methods and related systems described herein may include a human-machine interface (HMI) device that may include any device that enables the system to receive control input. Examples of input devices may include human interface inputs such as keyboards, mice, touchscreens, voice input devices, and other similar devices. The computing system may include a display device. The computing system may include hardware and software for outputting graphics and text information to the display device. The display device may include an electronic display screen, projector, printer or other suitable device for displaying information to a user or operator. The computing system may be further configured to allow interaction with remote HMI and remote display devices via the network interface device. The system may be implemented using one or multiple computing systems instead of a single computing system that implements all of the described features, however various features and functions may be separated and implemented by multiple computing units in communication with one another.

The present technology relates to a computer-operated method designed to provide guidance to a user through a hybrid processing system with a first step provided in line with established industry guidelines. This method thereby leverages both local and remote processing capabilities to ensure efficient and accurate responses to user inputs.

The method involves several key steps:
Receiving a User Input: The process begins with receiving a user input at a software interface, which could be a smartphone, personal computer, or any other electronic device. For example, the user input may comprise an invention disclosure, or a problem recognised and request for help.

Adding the user input to a first dataset: the user input is then added to a first dataset for processing in a first processing module. This first dataset may include earlier outputs from the second processing module, historical data, and other relevant information. The user input may pass through a first or initial processing stage based upon the first dataset, for example based upon standardised guidance or other local or general rules, which may organise the input for the first processing module and/or provide a preferred structure to processing the input. For example, an invention disclosure may be confidentially stored with inventive content removed - for example wherein the user may be enabled to excise or redact some or all of their input.

Processing the User Input Locally: The first processing module, which is located locally on the electronic equipment, processes the user input. This module analyses user request patterns, input history, and incorporates contextual information such as user location, time of day, device status, and current activity from the first dataset. The enhanced input is then generated. Overall, the enhanced input is a refined and improved version of the initial user input, guided and subsequently enriched with contextual and historical data and industry guidance, and accompanied by processing instructions.

This enhanced input is then either provided to the user or sent to the second processing module for further analysis and response generation, leveraging the computational power and large datasets available on remote servers. For example the field of the invention disclosure may be interrogated and/or an invention roadmap produced, such that the enhanced input may comprise predicted future steps and queries in relation to the best way forward with such steps, and/or a request for a prior art search on parsed integers from the invention disclosure, and/or an indication of technical data required to implement iterations of solutions to problems suggested by the invention disclosure.

Sending the enhanced input to a second processing module: the enhanced input, which includes processing instructions, is sent to a second processing module. This module operates on remote data servers and utilises a second dataset that may include a large language model (LLM).

Answering the Enhanced Input Remotely: The second processing module processes the input using the second dataset, which may include extensive computational power and large datasets. This module generates a comprehensive and accurate response to the enhanced input.

Receiving an output from the second processing module: the output generated by the second processing module is received back at the local device.

Relaying the Output to the User: The output is relayed to the user through the software interface, providing the user with the necessary guidance or response.

The second processing module may also be envisaged to be located at a remote server.

The enhanced input may thereby comprise an API (Application Programming Interface) call.

In this way the first processing module may provide a request to the second processing module that is tailored, augmented and maximised for efficiency with weights provided by the first dataset and first processing module.

The enhanced input may be envisaged to comprise a structure provided by the first processing module in light of the first dataset, which comprises the first dataset and weights for data and the dataset and/or inputs, which provides patterns to provide ‘filters’ or ‘finessing’ of the enhanced inputs.

The second processing module is envisaged to operate with and use a second dataset, as shown in FIG. 1. In the embodiment shown in FIG. 1, the second dataset is envisaged to comprise a large language model (LLM) which dataset may be held remote to the electronic equipment used for the first processing module.

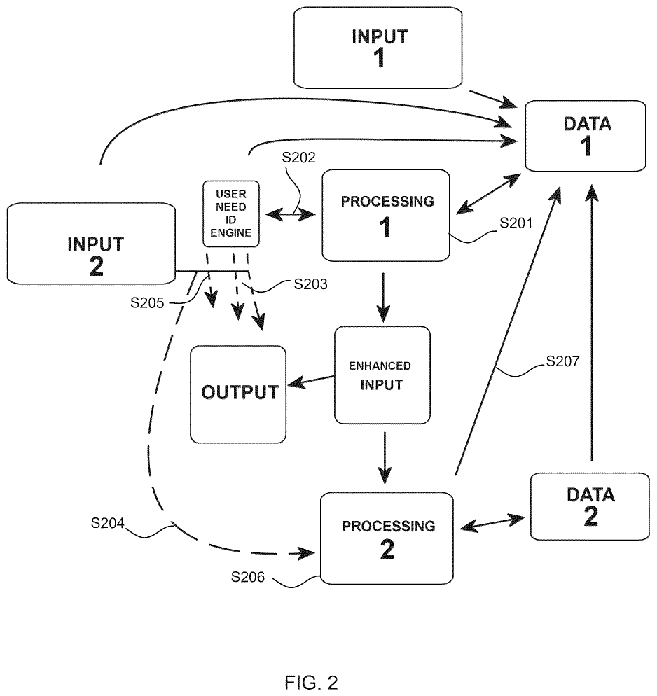

In the embodiments of the methods shown in FIGS. 1 and 2 the method comprises a first dataset that is held and enhanced locally on the electronic equipment in use, for example a smartphone. This dataset may be envisaged to be compressed or otherwise limited, so as to allow quick and effective processing and augmentation of the input, so as to create an enhanced input that may be passed to the second processing module.

This enhanced input in itself may be made available to the user, for example wherein the enhanced input shows issues to a user, for example through a user need identification engine, that need resolution, which the user can add to, answer or consider before or during sending to the second processing module, or where the user need identification engine in turn predicts that the enhanced input is sufficient as an output.

The method as shown in FIG. 2 comprises a method that is maximised for efficiency of guidance provision, so as to minimise downtime for the user, and thereby advantageously capitalise on the user's enthusiasm and/or inventiveness.

The embodiment of the method shown in FIG. 2 may be envisaged to use an artificial intelligence first processing module, such as machine learning, to prepare a plurality of enhanced inputs ready for the user's input as identified by the user need identification engine. Upon such input the enhanced input is thereby preprepared and/or cached.

This engine may provide predictive request modelling predicting future user inputs as well as iterating upon the input by leveraging the first dataset and:
Historical Data: Analysing the user's past requests and interactions.
Contextual Signals: Incorporating real-time contextual information to refine predictions.
Collaborative Filtering: Anonymously and securely utilizing aggregated data from other users to identify broader trends and predict potential requests.
Adaptive Cache Management: Dynamically managing the local dataset cache, including storage, retrieval, and update of cached responses based on factors like:
   Available Storage Space: Optimizing cache utilization based on device storage capacity.
   Data Freshness: Implementing mechanisms to refresh outdated or less relevant cached data.
   User Access Patterns: Prioritizing frequently accessed data for faster retrieval.
   Request Routing: Intelligently determining whether to fetch responses from the local cache or forward the request to the external AI model based on prediction confidence and data availability.
Offline Learning: Continuously refining its predictive model even when offline by:
   Analysing cached data: identifying patterns and trends within existing cached responses.
   Processing Offline User Interactions: Learning from user behaviour during offline periods to improve future predictions.

The process flow for the method as shown in FIG. 2 follows:
User request: Upon receiving a user input, the first processing module analyses the input and its context (S201).
   Contextual prediction: The user need identification engine predicts likelihood of the user needing related information based on:
   Historical data: Past inputs or requests from the user.
   Contextual cues: Current time, location, app usage patterns, etc.
   Collaborative filtering: Trends and patterns observed from other users.
Cache query: The user need identification engine prompts the first processing module to check the first dataset or local cache for a pre-cached response matching the user's input and potentially predicted future requests (S202).
Cache hit: If relevant responses are found in the cache, they are immediately returned to the user, providing a near-instantaneous response (S203).
Cache miss/partial hit: If the requested data is not available locally, the first processing module forwards the request to the second processing module (S204).

If some predicted data is available, it is displayed while the second processing module processes a main request, further reducing perceived latency (S205). Second processing module response and predictive fetching: The second processing module processes the request and returns the generated output (S206). Based on the first processing module' predictions, the second processing module may also generate and return additional data not explicitly requested by the user.

Adaptive cache update: The first processing module receives data from the second processing module (S207). The first processing module's adaptive caching algorithms determine data priority, storage duration, and potential for replacement based on available space and predicted relevance.

Continuous learning: The first processing module continuously learns from user interactions, explicit feedback, contextual changes, and potentially, anonymized and aggregated data from other users to improve its prediction accuracy and optimize the caching strategy. This learning occurs both online and offline.

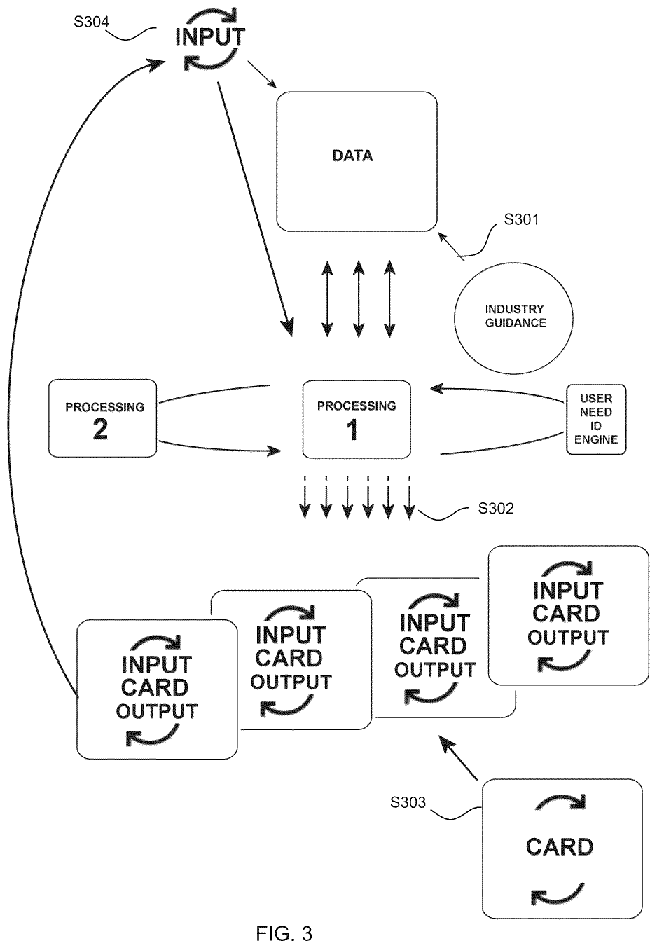

With reference to the embodiments of the method outlined in the figures the industry guidance data that are used to train the first processing means and may be added to the first dataset (see for example S301 of FIG. 3), which are comprised by guidance standards, may be chosen from guidance standards such as:
TRIZ: Theory of Inventive Problem Solving, a methodology for systematic innovation.
SCAMPER: A creative thinking technique using action verbs as stimuli.
Jobs-to-be-done (JTBD): Framework focusing on understanding customer needs.
5 Whys: Iterative interrogative technique used to explore cause-and-effect relationships.

In relation to the method as pictured in FIG. 3, the embodiment of the method describes a system of organisation of the inputs, enhanced inputs, and outputs, whereby such are stored, cached or handled as data cards, which may be locally or remotely available, recognised and/or processed.

The cards may be stored as outputs (S302), combined and/or used for future iterations, saved as cards to be used as future inputs and combinations thereof.

Additionally or alternatively, the cards may be organised or categorised or otherwise automatically or through user choice (S303), established as groupings, for example problem cards or solution cards, in which manner problem cards may be used to generate solution cards or further problem cards, and solution cards may be used to generate further problem cards or variations thereupon. In this way the cards may provide a visual and interactive means of presenting, categorising and prompting ideas for the user.

Cards may be combined or rearranged or restructured, on an interface for the user, or may be then used as further inputs (S304).

Additionally or alternatively, cards may be introduced into the method from external sources, for example uploaded, comprising multimodal creation of cards from interviews, internet sources, as well as Artificial Intelligence (AI) programs.

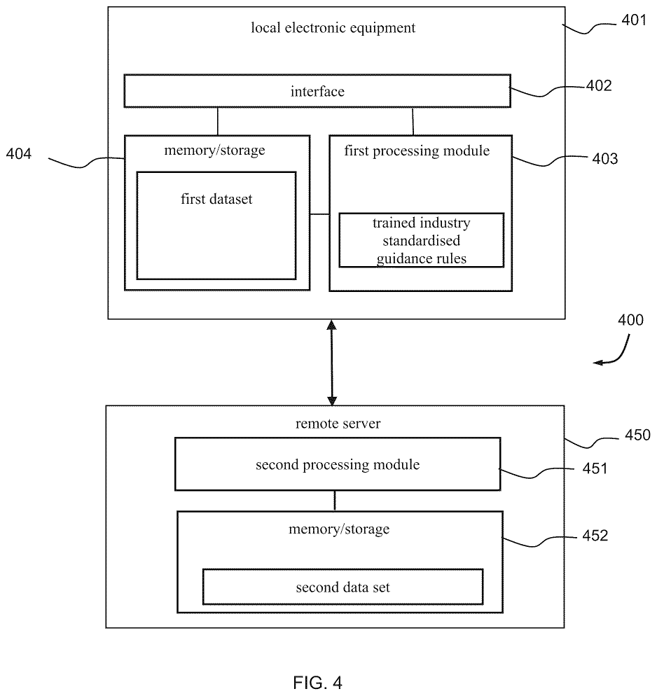

In some embodiments, the methods of providing guidance to a user using Artificial Intelligence illustrated in any of FIGS. 1 to 3 may be implemented by the computing system 400 of FIG. 4. Local electronic equipment 401 includes the interface 402, first processing module 403, and first data set stored in memory/storage 404. The remote server(s) 450 operably coupled to the local electronic equipment 401 includes the second processing module 451 and memory/storage 452 storing the second dataset.

The invention has been described by way of examples only and it will be appreciated that variation may be made to the above-mentioned embodiments without departing from the scope of protection as defined by the claims.

1. A computer operated method of providing guidance to a user using Artificial Intelligence, comprising the steps of:
receiving a user input at an interface;
adding the user input to a first dataset;
processing in a first processing module, wherein the first processing module has been trained including guidance rules for an industry;
processing the user input at the first processing module using the first dataset to produce an enhanced input;
sending the enhanced input to a second processing module;
answering the enhanced input using a second dataset in the second processing module;
receiving an output from the second processing module; and
relaying the output to the interface for the user.

2. A computer operated method of providing guidance to a user according to claim 1, wherein the enhanced input comprises processing instructions or weights for use in processing by the second processing module.

3. A computer operated method of providing guidance to a user according to claim 1, wherein the first dataset comprises earlier outputs from the second processing module.

4. A computer operated method of providing guidance to a user according to claim 1, wherein the first processing module is located locally on electronic equipment operating the method.

5. A computer operated method of providing guidance to a user according to claim 4, wherein the second processing module is operated on remote data servers.

6. A computer operated method of providing guidance to a user according to claim 1, wherein the first dataset comprises industry standardised guidance for processing the first dataset.

7. A computer operated method of providing guidance to a user according to claim 1, wherein the guidance rules for an industry include standardised as well as locally learnt factors and guidance rules for targeted guidance for users on progress of innovative entrepreneurial activities.

8. A computer operated method of providing guidance to a user according to claim 1, further comprising maintaining a version of the first dataset locally.

9. A computer operated method of providing guidance to a user according claim 1, further comprising a step of predicting future user inputs by leveraging the first dataset.

10. A computer operated method of providing guidance to a user according to claim 9, further comprising a step of contemporaneously preparing a plurality of the enhanced inputs locally for instantaneous sending to the second processing module.

11. A computer operated method of providing guidance to a user according to claim 1, wherein the second dataset comprises a large language model.

12. A computer operated method of providing guidance to a user according to claim 1, wherein processing in the first processing module comprises analysing user request patterns, input, history, and incorporating contextual information including the standardised guidance rules.

13. A computer operated method of providing guidance to a user according to claim 12, wherein the standardised guidance rules comprise TRIZ, SCAMPA or 5 Whys.

14. A computer operated method of providing guidance to a user according to claim 1, further comprising a pre-processing stage to receive a functional representation of an input from the user and add this to the first dataset as well as a prompt to the first processing module.

15. A computer operated method of providing guidance to a user according to claim 1, the method further comprising:
operation of a user need identification engine to predict if the enhanced input is sufficient to provide an output for the user and relaying the enhanced input to the user and if the user need identification engine predicts the enhanced input is not sufficient as an output, performing the step of sending the enhanced input to a second processing module.

16. A computer operated method of providing guidance to a user using Artificial Intelligence, comprising the steps of:
receiving a user input at an interface;
adding the user input to a first dataset;
processing the input in a first processing module, wherein the first processing module has been trained including guidance rules for an industry;
interrogating the first dataset to predict inputs;
processing a plurality of user inputs at the first processing module to produce enhanced inputs;
sending one or more enhanced input to a second processing module;
answering the enhanced input using a second dataset in the second processing module;
receiving an output from the second processing module; and
relaying the output to the interface for the user.

17. A non-transitory, computer-readable medium comprising program code that, when executed by one or more processors of a computer system, causes the one or more processors to perform a method of providing guidance to a user using artificial intelligence, the method comprising
receiving a user input at an interface;
adding the user input to a first dataset;
processing in a first processing module, wherein the first processing module has been trained including guidance rules for an industry;
processing the user input at the first processing module using the first dataset to produce an enhanced input;
sending the enhanced input to a second processing module;
answering the enhanced input using a second dataset in the second processing module;
receiving an output from the second processing module; and
relaying the output to the interface for the user.

18. A non-transitory, computer-readable medium as claimed in claim 17, wherein in the method the first processing module is located locally on electronic equipment operating the method.

19. A non-transitory, computer-readable medium as claimed in claim 18, wherein in the method the second processing module is operated on remote data servers.

20. A non-transitory, computer-readable medium as claimed in claim 17, wherein in the method the guidance rules for an industry include standardised as well as locally learnt factors and guidance rules for targeted guidance for users on progress of innovative entrepreneurial activities.
